(19) United States
(12) Patent Application Publication
(10) Pub. No.: US 2026/0333539 A1
(43) Pub. Date: Oct. 22, 2026

(54) LED DRIVING CHIP, AND LED ADAPTIVE HEADROOM CONTROL SYSTEM AND METHOD

(71) Applicant: ETA SEMICONDUCTOR LIMITED, Nantong (CN)

(72) Inventors: Bin HU, Nantong (CN); Lu SUN, Nantong (CN); Mingming HOU, Nantong (CN)

(21) Appl. No.: 19/108,676

(22) PCT Filed: Apr. 11, 2024
(86) PCT No.: PCT/CN2024/087270

§ 371 Date: Mar. 4, 2025

(30) Foreign Application Priority Data
Apr. 23, 2023 (CN) 202310450271.6

(51) Int. Cl. H05B 45/347

(52) U.S. Cl. CPC H05B 45/347

(57) ABSTRACT

The present invention provides an LED driver chip, LED AHC system and method, wherein the LED driver chip comprises an AHC module to obtain its own voltage regulation information and a Judge module to obtain aggregate voltage regulation information; the LED AHC system comprises a daisy-chain formed by at least 2 LED driver chips and an MCU, wherein the last LED driver chip on the daisy-chain can summarize the voltage regulation information of all LED driver chips on the same daisy-chain, and adjust the LED power voltage based on the voltage regulation information. The FB terminal of the non-last LED driver chip on the daisy-chain may be suspended or participate in voltage regulation simultaneously. The Present Invention belongs to the field of electronic circuit technology and has benefits such as reducing complexity of PCB wiring, realizing precise adaptive voltage regulation, simplifying MCU computation and improving communication efficiency of data bus. It can also be used in multiple daisy-chain structures and supports more flexible FB terminal use, making LED power voltage regulation more intelligent and efficient.

### TECHNICAL FIELD

The present invention involves the field of electronic circuit technology, particularly LED driver chip, LED AHC system and method.

### BACKGROUND TECHNOLOGY

Light Emitting Diode (LED) is a semiconductor component that converts electrical signals into optical signals. Its VA characteristic curve is shown in FIG. 1. When the forward voltage of LED is higher than the threshold voltage, the LED conducts in the forward direction, and is in the forward zone. The voltage at both ends of LED is related to various factors, e.g. LED brightness, ambient temperature and production batch, etc. Therefore, changes in LED brightness, ambient temperature and production batch will cause changes in the voltage drop at both ends of LED.

LED driver chip is a type of chip that provides stable working state and protection for LED lights, while controlling the brightness of LED lights. A typical topology structure of LED driver chip is shown in FIG. 2, where V_{LED} is the external power voltage for the LED light string. The LED driver chip provides stable current to several LED light strings by several internal current sinks. By controlling the magnitude of current, the LED lights can be dimmed. Based on the aforementioned VA characteristics of LED, when factors such as LED brightness, ambient temperature and production batch change, the voltage drop of LED string will change accordingly. If the external power voltage V_{LED} of LED string remains unchanged, when the voltage drop of LED string bucks, it will cause the headroom voltage at the output (OUT) port of LED driver chip to boost, resulting in additional power loss and reducing the working efficiency of driver chip. When the voltage drop of LED string boosts, it will cause buck in the headroom voltage at the OUT port of LED driver chip. If the headroom voltage is too low, it will cause the internal current sink of LED driver chip not to work properly, thereby affecting the normal operation of LED driver chip.

To solve the above problems, people have thought of bucking the external power voltage V_{LED} to reduce system power consumption at low voltage drop of LED, and boosting the external power voltage V_{LED} to ensure the normal operation of current sink at high voltage drop of LED, so as to maintain the headroom voltage at the OUT terminal of LED driver chip within a reasonable range. Therefore, Adaptive Headroom Control (AHC) technology has been proposed. The principle of AHC technology is shown in FIG. 3. Vh is the expected headroom voltage value at the OUT terminal of LED driver chip. When the value of headroom voltage at any OUT terminal of LED driver chip is lower than Vh, it means that the voltage of current sink corresponding to that OUT terminal is too low. At this time, the external power voltage VLED should be boosted to ensure the normal operation of current sink. When the headroom voltage at all OUT terminals is higher than Vh, it means that the voltage drop of all LED light strings is relatively low. At this time, the external power voltage V_{LED} should be bucked to reduce power consumption.

A typical topology structure of LED driver chip using AHC technology is shown in FIG. 4. Each OUT terminal of LED driver chip has a corresponding comparator inside the LED driver chip to compare the headroom voltage of OUT terminal with the expected headroom voltage Vh. The comparison result is given to the internal AHC module, which collects the comparison results of all OUT terminals of LED driver chip to control the current sink of output feedback (FB) terminal of LED driver chip. The FB terminal of LED driver chip is connected to the FB circuit of DC-DC voltage converter outside the LED driver chip, which provides external power voltage V_{LED} for the LED string.

In some application scenarios, multiple LED driver chips are required to control multiple strings of LED lights. Each LED driver chip controls more than one string of LED lights, and multiple strings of LED lights are uniformly supplied with external power voltage V_{LED} by a DC-DC voltage converter. At this point, AHC technology is adopted to coordinate the headroom voltage values of OUT terminals of multiple LED driver chips to adaptively control the external power voltage V_{LED} of LED string.

FIG. 5 shows the topology diagram of an LED AHC system composed of multiple LED driver chips in the prior art. Micro Control Unit (MCU) configures the operating parameters of each LED driver chip via a daisy-chain communication bus (BUS). The FB terminals of each LED driver chip are connected together, and the AHC module of all LED driver chips controls the current sink at FB terminal of each LED driver chip to jointly provide FB circuit control current for the DC-DC voltage converter. Due to the fact that the FB terminal of each LED driver chip needs to be connected to the FB circuit of DC-DC voltage converter, this system will increase the wiring complexity of Printed Circuit Board (PCB) of the entire lamp board. Meanwhile, due to the unknown boost/buck information required between each LED driver chip, the boost/buck information reflected in the FB circuit of DC-DC voltage converter may cancel each other out, resulting in the inability to achieve adaptive voltage regulation.

FIG. 6 shows the topology diagram of another LED AHC system composed of multiple LED driver chips in the prior art. This structure connects multiple LED driver chips via a daisy-chain BUS using MCU. Instead of controlling the FB circuit current of DC-DC voltage converter separately through the FB terminal of each driver chip, the voltage information at OUT terminal of each driver chip is read back via the MCU BUS. The AHC module of MCU summarizes the final boost/buck information, and controls the DC-DC voltage converter to perform boost/buck. The final boost/buck information is based on the aforementioned AHC control principle. When the MCU detects that the headroom voltage at any OUT terminal of any LED driver chip is lower than the expected headroom voltage Vh, the AHC module of MCU controls the DC-DC voltage converter to boost. When the headroom voltage at all OUT terminals of all LED driver chips is higher than Vh, the AHC module of MCU controls the DC-DC voltage converter to buck. This system can coordinate the boost/buck information of all LED driver chips to achieve precise adaptive voltage control (AVC), and the FB terminal of each LED driver chip does not need to participate in voltage regulation, reducing the wiring complexity of lamp board PCB. However, the MCU of this system not only needs to configure the working parameters of each LED driver chip, but also needs to read back the OUT voltage information of each LED driver chip and perform comprehensive processing, which will greatly increase the workload of MCU, occupy the computing resources of MCU, and reduce the communication efficiency of system bus.

FIG. 7 shows the topology diagram of another LED AHC system composed of multiple LED driver chips in the prior art. Each LED driver chip in this system is equipped with an additional FB input (FBI) port to connect with the FB output (FBO) port of the previous LED driver chip. The principle is that the AHC module of the first LED driver chip collects the comparison results between the headroom voltage of all its OUT terminals and the expected headroom voltage Vh. If the headroom voltage of any OUT terminal is lower than Vh, the AHC module outputs a specific voltage value lower than Vh to the FBO port, which means that the first LED driver chip expects the LED supply voltage to increase. If the headroom voltage of all OUT terminals is higher than Vh, the AHC module outputs a specific voltage value higher than Vh to the FBO port, which means that the first LED driver chip expects the LED power voltage to decrease. Starting from the second LED driver chip, its AHC module simultaneously collects the comparison results between the OUT terminal headroom voltage of LED driver chip and the expected headroom voltage Vh, as well as the comparison results between the voltage value of previous LED driver chip and the expected headroom voltage Vh transmitted from the FBI of LED driver chip. If any voltage is lower than Vh, the AHC module outputs a specific voltage value lower than Vh to the FBO port, which means that the expected LED supply voltage of the first two LED driver chip increases. If all voltages are higher than Vh, the AHC module outputs a specific voltage value higher than Vh to the FBO port, which means that the first two LED driver chips expect the LED power voltage to decrease, and so on. The AHC module of the last LED driver chip will receive a summary of the voltage regulation information of all LED driver chips on the same daisy-chain, and then achieve final result of voltage regulation. When the LED driver chip determines that it is the last LED driver chip, it will output the corresponding voltage to the DC-DC voltage converter through its FBO port to determine the adjustment of final LED power voltage. This system connects the FBI port and FBO port of LED driver chip in series to transmit voltage information of analog signals, so that the last LED driver chip can receive the voltage regulation information of all LED driver chips on the same daisy-chain, so as to achieve precise voltage regulation. MCU does not participate in specific voltage regulation, which can simplify the MCU's computational complexity. However, the system requires the addition of an additional receiving port FBI for each LED driver chip, and the FBI port and FBO port need to be interconnected, thereby increasing the complexity of PCB wiring.

### SUMMARY OF THE INVENTION

To solve at least one of the above technical problems, the present invention provides an LED driver chip, an LED AHC system and method, which can reduce PCB wiring complexity, simplify MCU computation, and improve communication efficiency of BUS while achieving precise voltage regulation when driving multiple LED light strings.

The first aspect of the Present Invention provides an LED driver chip, which is implemented by the following technical scheme.

LED driver chip includes:
AHC module, used to collect the headroom voltage information of all output (OUT) terminals such chip and summarize it to obtain the local voltage regulation information of LED driver chip;
Judge module, connected to the AHC module such chip, and receive the own regulating information sent by the AHC module such chip; and,
When at least two LED driver chips are connected to a Micro Control Unit (MCU) via BUS to form a daisy-chain, the Judge module is also used for:
Obtain the aggregate voltage regulation information such chip based on the local voltage regulation information sent by the AHC module such chip, or the aggregate voltage regulation information of previous LED driver chip on the same daisy-chain sent via BUS and the local voltage regulation information sent by the AHC module such chip; meanwhile,
Send the aggregate voltage regulation information such chip to the next LED driver chip on the same daisy-chain via BUS, or, when its LED driver chip is the last LED driver chip on the daisy-chain, control the current sink of output feedback (FB) end such chip according to the aggregate voltage regulation information such chip to adjust the LED supply voltage output by the DC-DC voltage converter.

Preferably, when the LED driver chip is the first LED driver chip on the daisy-chain, its Judge module is also used to obtain the aggregate voltage regulation information such chip based on the own regulating information sent by the AHC module such chip.

Preferably among all the above schemes, when the LED driver chip is not the first LED driver chip on the daisy-chain, its Judge module is also used to obtain the aggregate voltage regulation information such chip based on the aggregate voltage regulation information of the previous LED driver chip sent by previous LED driver chip on the same daisy-chain via BUS and the local voltage regulation information sent by the AHC module such chip.

Preferably among all the above schemes, when the LED driver chip is the last LED driver chip on the daisy-chain, its Judge module is also used to control the current sink of FB terminal of LED driver chip based on the aggregate voltage regulation information of its affiliated LED driver chip, so as to adjust the LED supply voltage output by the DC-DC voltage converter.

Preferably among all the above schemes, when the LED driver chip is not the last LED driver chip on the daisy-chain, its Judge module is also used to send the aggregate voltage regulation information of its corresponding LED driver chip to the next LED driver chip on the same daisy-chain via BUS.

Preferably among all the above schemes, when the LED driver chip is not the last LED driver chip on the daisy-chain, its FB terminal is suspended. Alternatively, its FB terminal can be connected to the FB circuit of DC-DC voltage converter to jointly affect the LED supply voltage regulated by the DC-DC voltage converter with the last LED driver chip on the same daisy-chain.

Preferably among all the above schemes, the local voltage regulation information of LED driver chip is boost, and/or when the aggregate voltage regulation information received from the previous LED driver chip on the same daisy-chain is boost, the aggregate voltage regulation information of the driver chip is boost.

The second aspect of the Present Invention provides an LED AHC system, which is implemented through the following technical solution.

LED AHC system, comprising at least 1 daisy-chain formed by connecting at least 2 LED driver chips to MCU via BUS. For the LED driver chips on the same daisy-chain, the output FB terminal of last LED driver chip is connected to the FB circuit of the DC-DC voltage converter to provide control current to the FB circuit of DC-D voltage converter.

Preferably, all LED driver chips on the same daisy-chain except for the last one shall be suspended to the FB terminal.

Preferably among all the above schemes, for LED driver chips on the same daisy-chain, at least 1 LED driver chip from the other LED driver chips except for the last one is connected to the FB circuit of DC-DC voltage converter at its FB terminal, so as to jointly affect the LED supply voltage regulated by the DC-DC voltage converter with the last LED driver chip on the same daisy-chain.

The third aspect of the Present Invention provides an LED AHC method, which is implemented through the following technical solution.

LED AHC method, comprising periodical execution of:
The first LED driver chip on daisy-chain collects the headroom voltage information of its OUT terminal to form its own voltage regulation information, and sends the local voltage regulation information as the aggregate voltage regulation information of the driver chip to the next LED driver chip on the same daisy-chain via BUS;
Other LED driver chips on the daisy-chain, except for the first and last LED driver chips, collect the headroom voltage information of their OUT terminals to form their own voltage regulation information, and based on the local regulation information and the summary regulation information of the previous LED driver chip sent by the previous LED driver chip, obtain the summary regulation information of LED driver chip, and send the summary regulation information of LED driver chip to the next LED driver chip via BUS;
The last LED driver chip on the daisy-chain collects the headroom voltage information of its OUT terminal to form its own voltage regulation information, and obtains the total voltage regulation information of LED driver chip based on the local voltage regulation information and the aggregate voltage regulation information of the previous LED driver chip sent by the previous LED driver chip, and based on the aggregate voltage regulation information of the LED driver chip, controls the current sink of output FB terminal of LED driver chip to boost/buck, so as to adjust the LED supply voltage output by the DC-DC voltage converter.

Preferably, the daisy-chain is composed of at least 2 LED driver chips connected to MCU via BUS.

Preferably among all the above schemes, the LED driver chips on the same daisy-chain, except for the last LED driver chip, which does not participate in the regulation of the LED supply voltage output by the DC-DC voltage converter, shall suspend its FB terminals.

Preferably among all the above schemes, for LED driver chips on the same daisy-chain, at least 1 LED driver chip from the other LED driver chips except for the last one is connected to the FB circuit of DC-DC voltage converter at its FB terminal, so as to jointly affect the LED supply voltage regulated by the DC-DC voltage converter with the last LED driver chip on the same daisy-chain.

Preferably among all the above schemes, the local voltage regulation information of LED driver chip is boost, or when the aggregate voltage regulation information received from the previous LED driver chip on the same daisy-chain is boost, the aggregate voltage regulation information of the driver chip is boost.

The LED driver chip, LED AHC system and method of the Present Invention have the following benefits:
1. Only the FB terminal of the last LED driver chip on the daisy-chain needs to be connected to the FB circuit of DC-DC voltage converter, while the FB terminals of other LED driver chips on the daisy-chain may be suspended, greatly simplifying the wiring complexity of PCB board;
2. The voltage regulation information of LED driver chips on the daisy-chain is transmitted and summarized via BUS, so that the voltage regulation information of the last LED driver chip on the daisy-chain combines the voltage regulation information of all previous LED driver chips, thereby achieving precise adaptive voltage regulation;
3. MCU is only used to configure the parameters of various LED driver chips via BUS, instead of participating in specific voltage regulation, thus reducing the computational load of MCU and improving the communication efficiency of BUS;
4. The member of daisy-chains may be adjusted based on the number of LED driver chips, while supporting more flexible adjustment of the FB terminal of LED driver chip subject to the actual wiring situation of PCB board, making the adjustment of LED power voltage more intelligent and efficient.

### BRIEF DESCRIPTION OF THE DRAWINGS

FIG. 1 shows the VA characteristic curve of LED;

FIG. 2 is a topological structure diagram of the typical LED driver chip;

FIG. 3 is a diagram of AHC technology principle of LED driver chip;

FIG. 4 is a topological structure diagram of LED driver chip with AHC technology;

FIG. 5 is a topological structure diagram of LED AHC system composed of multiple LED driver chips in the prior art;

FIG. 6 is a topological structure diagram of another LED AHC system composed of multiple LED driver chips in the prior art;

FIG. 7 is a topological structure diagram of a third LED AHC system composed of multiple LED driver chips in the prior art;

FIG. 8 is a structure diagram of a preferred example of LED driver chip based on the Present Invention;

FIG. 9 is a topological structure diagram of a preferred example of the LED AHC system based on the Present Invention;

FIG. 10 is a topological structure diagram of another example of the LED AHC system based on the Present Invention;

FIG. 11 is a topological structure diagram of a third example of the LED AHC system based on the Present Invention;

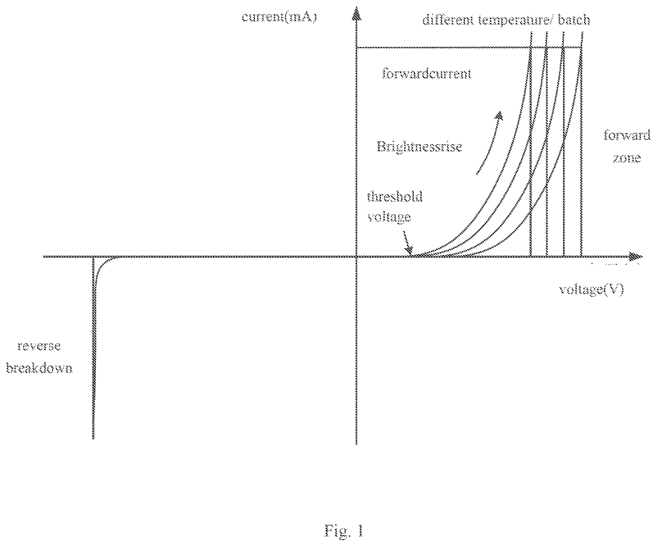

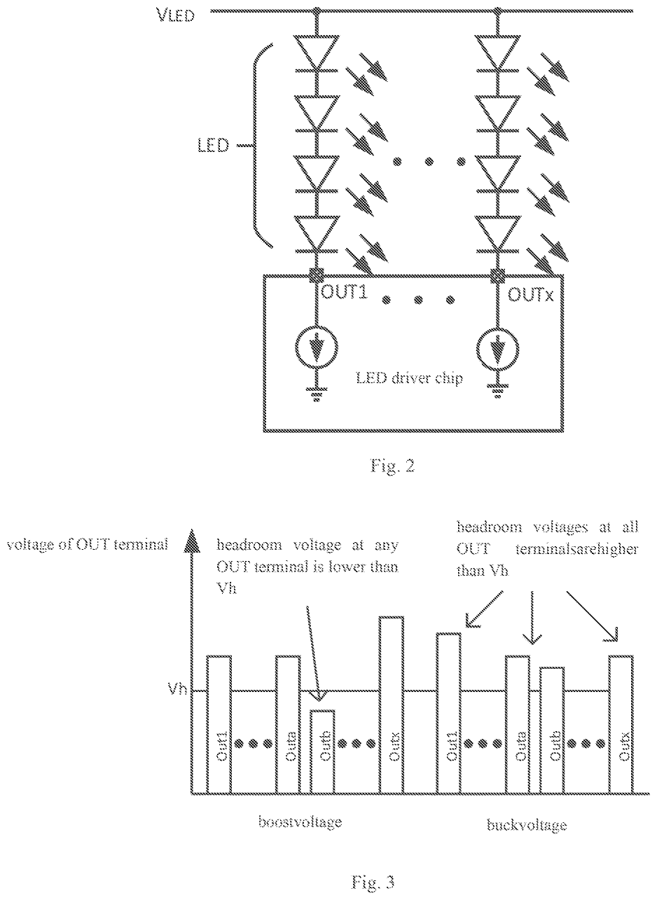

### DESCRIPTION OF THE ENABLING EMBODIMENT

To better understand the Present Invention, the following provides a detailed description of the Present Invention in conjunction with specific examples.

### Example 1

As shown in FIG. 8, an LED driver chip comprises:
AHC module, used to collect the headroom voltage information of all output (OUT) terminals such chip and summarize it to obtain the local voltage regulation information of LED driver chip;
Judge module, connected to the AHC module such chip, and receive the own regulating information sent by the AHC module such chip; and,
When at least two LED driver chips are connected to a Micro Control Unit (MCU) via BUS to form a daisy-chain, the Judge module is also used for:
Obtain the aggregate voltage regulation information such chip based on the local voltage regulation information sent by the AHC module such chip, or the aggregate voltage regulation information of previous LED driver chip on the same daisy-chain sent via BUS and the local voltage regulation information sent by the AHC module such chip; meanwhile,
Send the aggregate voltage regulation information such chip to the next LED driver chip on the same daisy-chain via BUS, or, when its LED driver chip is the last LED driver chip on the daisy-chain, control the current sink of output feedback (FB) end such chip according to the aggregate voltage regulation information such chip to adjust the LED supply voltage output by the DC-DC voltage converter.

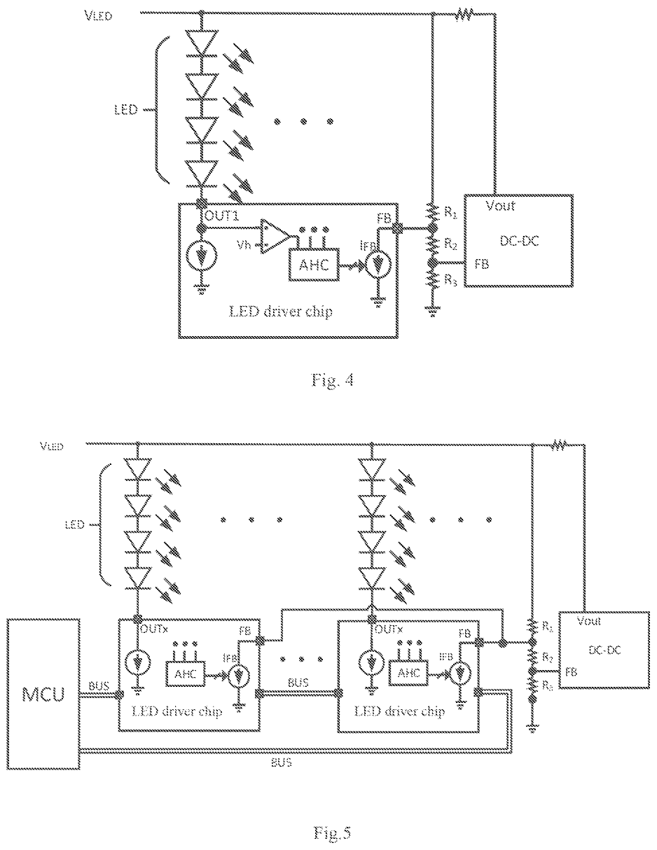

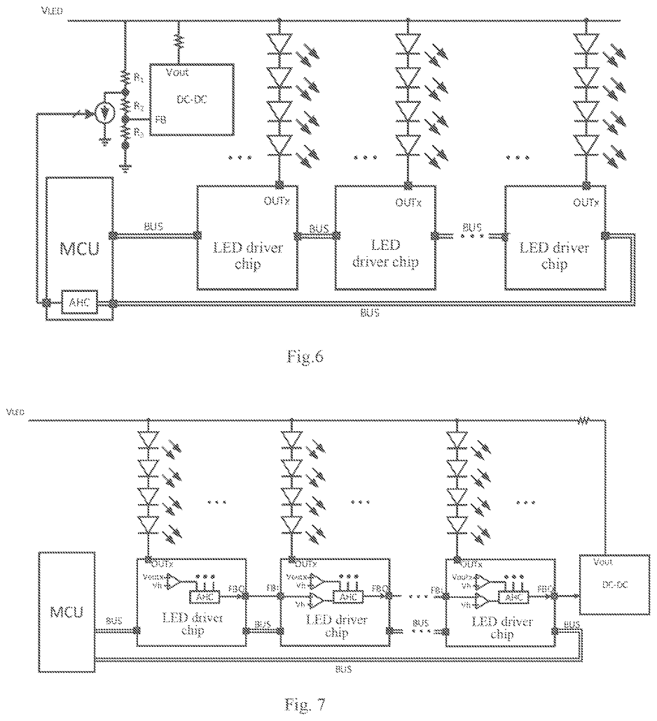

It should be noted that the AHC module can collect the headroom voltage information of all OUT terminals such chip with the method shown in FIG. 4. That is, within the LED driver chip, a comparator is set up for each OUT terminal of the LED driver chip to compare the headroom voltage of OUT terminal with the expected headroom voltage Vh, and all comparison results are given to the AHC module, thereby achieving the collection of headroom voltage information of all OUT terminals such chip by the AHC module. When the AHC module determines that the headroom voltage at all OUT terminals such chip is higher than the expected headroom voltage Vh, the local voltage regulation information obtained is buck. Otherwise, or in other words, as long as the headroom voltage of 1 OUT terminal is lower than the expected headroom voltage Vh, the obtained local voltage regulation information is boost.

In this example, it is preferred that when the LED driver chip is the first one on the daisy-chain, its Judge module is also used to obtain the aggregate voltage regulation information such chip based on the local voltage regulation information sent by the AHC module such chip. When the LED driver chip is not the first one on the daisy-chain, its Judge module is also used to obtain the aggregate voltage regulation information such chip based on the aggregate voltage regulation information of the previous LED driver chip sent by such chip on the same daisy-chain via BUS and the local voltage regulation information sent by the AHC module such chip.

That is to say: (1) For the first LED driver chip on the daisy-chain, the aggregate voltage regulation information obtained by the Judge module totally depends on the local voltage regulation information sent by the AHC module connected to it. More specifically if the own regulating information sent by the AHC module is boost, then the summarized regulating information obtained by the Judge module is boost, too. If the own regulating information sent by the LED module is buck, then the summary regulating information obtained by the Judge module is buck, too. (2) For non-first LED driver chips on the daisy-chain, the aggregate voltage regulation information obtained by the Judge module is determined by the local voltage regulation information such chip sent by the AHC module connected to it, and the aggregate voltage regulation information of the previous LED driver chip sent by such chip on the same daisy-chain via BUS. More specifically, if the local voltage regulation information sent by the AHC module is boost, or if the aggregate voltage regulation information sent by the previous LED driver chip is boost, then the aggregate voltage regulation information obtained by the Judge module for that LED driver chip is boost, too. Only when the local voltage regulation information sent by the AHC module and the aggregate voltage regulation information sent by the previous LED driver chip are both buck, the aggregate voltage regulation information of LED driver chip obtained by the Judge module will be buck, too. In conclusion, the local voltage regulation information of LED driver chip is boost, and/or when the aggregate voltage regulation information received from the previous LED driver chip on the same daisy-chain is boost, the aggregate voltage regulation information of the driver chip is boost.

In this example, it is further preferred that, when the LED driver chip is not the last LED driver chip on the daisy-chain, its Judge module is also used to send the aggregate voltage regulation information of its corresponding LED driver chip to the next LED driver chip on the same daisy-chain via BUS. When the LED driver chip is the last LED driver chip on the daisy-chain, its Judge module is also used to control the current sink of FB terminal of LED driver chip based on the aggregate voltage regulation information of its affiliated LED driver chip, so as to adjust the LED supply voltage output by the DC-DC voltage converter.

It should be noted that for the last LED driver chip on the daisy-chain, its FB terminal is connected to the FB circuit of DC-DC voltage converter, d the Judge module is connected to the current sink of FB terminal of LED driver chip. By controlling the current I_{FB} of the current sink to boost or buck by a set value, the current of FB circuit of DC-DC voltage converter may be adjusted, thereby adjusting the boost/buck of LED supply voltage output by the DC-DC voltage converter.

In this example, it is further preferred that, when the LED driver chip is not the last LED driver chip on the daisy-chain, its FB terminal is suspended. Alternatively, its FB terminal can be connected to the FB circuit of DC-DC voltage converter to jointly affect the LED supply voltage regulated by the DC-DC voltage converter with the last LED driver chip on the same daisy-chain. It should be noted that when the FB terminal of the non-last LED driver chip on the daisy-chain is connected to the FB circuit of DC-DC voltage converter, it only affects the time it takes for the DC-DC voltage converter to adjust the output LED supply voltage, instead of affecting the accuracy of total amount of voltage regulation.

### Example 2

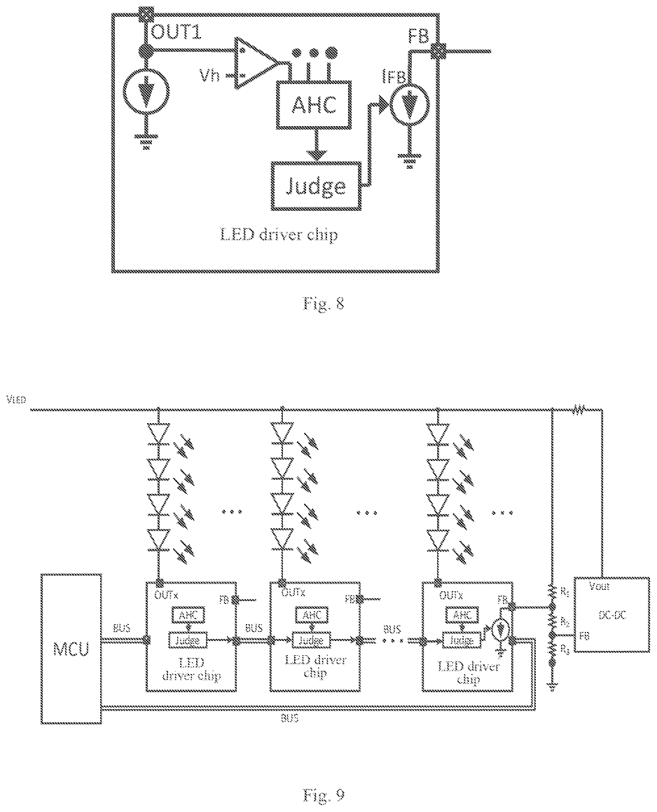

As shown in FIG. 9, an LED AHC system comprises a daisy-chain formed by connecting at least 2 LED driver chips from Example 1 to MCI via BUS. For the LED driver chips on the daisy-chain, the output FB terminal of the last LED driver chip is connected to the FB circuit of DC-DC voltage converter to provide control current to the FB circuit of DC-DC voltage converter. The FB terminals of all LED driver chips, except for the last one, are suspended and do not participate in the regulation of LED supply voltage output by the DC-DC voltage converter.

It should be understood that in the LED AHC system, the OUT terminal of each LED driver chip may be connected to the first terminal of an LED string, and the second terminal of each LED string may be connected to the output terminal (Vout pin in the figure) of DC-DC voltage converter. The FB circuit of DC-DC voltage converter includes a first resistor R1, a second resistor R2 and a third resistor R3 connected in series. The FB terminals of the DC-DC voltage converter are connected between the second resistor R2 and the third resistor R3. The FB terminal of the last LED driver chip on the daisy-chain is connected between the first resistor R1 and the second resistor R2. The end of the first resistor R1 far from the second resistor R2 is connected to the second end of each LED string, and the end of the bird resistor R3 far from the second resistor R2 is connected to the ground.

When the LED AHC system operates, the following LED AHC method is adopted, which is executed periodically:
Step 1: The first LED driver chip on daisy-chain collects the headroom voltage information of its OUT terminal to form its own voltage regulation information, and sends the local voltage regulation information as the aggregate voltage regulation information of the driver chip to the next LED driver chip on the same daisy-chain via BUS;
Step 2: Other LED driver chips on the daisy-chain, except for the first and last LED driver chips, collect the headroom voltage information of their OUT terminals to form their own voltage regulation information, and based on the local regulation information and the summary regulation information of the previous LED driver chip sent by the previous LED driver chip, obtain the summary regulation information of LED driver chip, and send the summary regulation information of LED driver chip to the next LED driver chip via BUS;
Step 3: The last LED driver chip on the daisy-chain collects the headroom voltage information of its OUT terminal to form its own voltage regulation information, and obtains the total voltage regulation information of LED driver chip based on the local voltage regulation information and the aggregate voltage regulation information of the previous LED driver chip sent by the previous LED driver chip, and based on the aggregate voltage regulation information of the LED driver chip, controls the current sink of output FB terminal of LED driver chip to boost/buck, so as to adjust the LED supply voltage output by the DC-DC voltage converter.

The daisy-chain is composed of at least 2 LED driver chips connected to MCU via BUS.

Specifically, in step 1, the LED driver chip may refer to the existing technology methods (such as the method corresponding to FIG. 4) to determine its own voltage regulation information as boost or buck, and then send its own voltage regulation information as the aggregate voltage regulation information of LED driver chip to the next LED driver chip. If the own regulating information is boost, then summarizing the regulating information is boost, too. If the own regulating information is buck, then summarizing the regulating information is buck, too. It should be understood that in Step 1, the aggregate voltage regulation information is sent to the next LED driver chip via BUS, that is to say, the aggregate voltage regulation information is sent to the next LED driver chip in form of digital signal.

More specifically, in Step 2, the second LED driver chip on the daisy-chain receives the aggregate voltage regulation information sent by the first LED driver chip, integrates the received aggregate voltage regulation information with its own voltage regulation information to obtain the aggregate voltage regulation information of the second LED driver chip, and sends the aggregate voltage regulation information of the second LED driver chip to the third LED driver chip via BUS in form of digital signal. The third LED driver chip integrates the received aggregate voltage regulation information with its own voltage regulation information to obtain the aggregate voltage regulation information of the third LED driver chip, and sends the aggregate voltage regulation information of the third LED driver chip to the fourth LED driver chip via BUS in form of digital signal. Repeat this process till the second to last LED driver chip on the daisy-chain sending its voltage regulation information to the last LED driver chip. It should be noted that when the own regulating information of the LED driver chip is boost or the aggregate voltage regulation information receiving from the previous LED driver chip on the same daisy-chain is boost, the aggregate voltage regulation information of the LED driver chip is boost, too. Only when the own regulating information of the LED driver chip and the aggregate voltage regulation information receiving from the previous LED driver chip on the same daisy-chain are both buck, the aggregate voltage regulation information of the LED driver chip will be buck.

More specifically, in Step 3, when the aggregate voltage regulation information of the last LED driver chip on the daisy-chain is boost, the LED driver chip controls the current IFB of its FB terminal current sink to boost to the set value. When the voltage is buck, it controls the current IFB of current sink at the FB terminal to buck by the set value. The boost/buck of current IFB through the current sink at the FB terminal may affect the boost/buck of LED supply voltage output by the DC-DC voltage converter.

The range of the current IFB of FB terminal current sink of the last LED driver chip controller is [0, I_{FB_FS}]. When the I_{FB} value is the minimum value of 0, the external power voltage V_{LED} of LED string is the smallest:

$${V}_{{LED}_{MIN}} = {V}_{{FB}_{DCDC}} \times ( \frac{{R}_{1} + {R}_{2}}{{R}_{3}} + 1 ) ,$$

where V_{FB_DCDC} is the voltage at the FB terminal of DC-DC voltage converter. When the value of I_{FB} is at its maximum I_{FB_FS}, the external power voltage V_{LED} of the LED string is at its maximum: V_{LED}_{_{MAX}}=V_{LED}_{_{MIN}}+I_{FB}_{_{FS}}×R₁. The last LED driver chip controls the current I_{FB} of its FB terminal current sink to boost or buck within the range of Δ I_{FB}, and the change in the external power voltage V_{LED} of LED string is: ΔV_{LED}=ΔI_{FB}×R₁. The LED AHC system may achieve adaptive, dynamic and precise adjustment of the external power voltage of LED light string by periodically executing the LED AHC method.

### Example 3

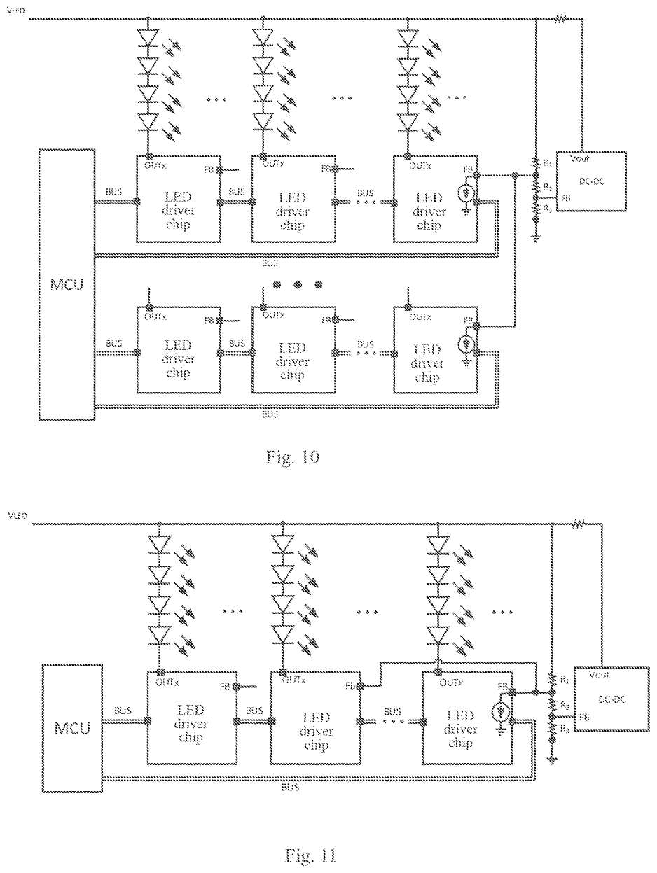

This example is similar to Example 2, but in this example, it is preferred that, as shown in FIG. 10, the LED AHC system includes multiple daisy-chains, each of which includes at least 2 LED driver chips from Example 1. The FB terminal of the last LED driver chip on each daisy-chain is connected to the FB circuit of DC-DC voltage converter, jointly controlling the FB circuit current of DC-DC voltage converter. The FB terminals of other LED driver chips on each daisy-chain, except for the last LED driver chip, are suspended.

When the LED AHC system operates, each daisy-chain executes the LED AHC method.

The topology structure of this example is appropriate to situations where MCU needs to control more LED driver chips, but is limited by the communication efficiency of daisy-chain and it is impossible to connect all LED driver chips on the same daisy-chain. Through the topology structure of this example, the MCU can control more LED driver chips, and the OUT terminal voltage of all LED driver chips can be involved in the voltage regulation operation to achieve precise adaptive adjustment of the external power voltage of LED string.

It should be understood that for this topology, the change in FB circuit current of DC-DC voltage converter during each voltage regulation is the sum of current changes in the FB terminal current sink of the last LED driver chip on all daisy-chains.

### Example 4

This example is similar to example 2, but the preferred option in this example is an LED AHC system. In addition to the last LED driver chip on the daisy-chain, the FB terminal of at least 1 other LED driver chip may be connected to the FB circuit of DC-DC voltage converter to jointly affect the LED supply voltage regulated by the DC-DC voltage converter with the last LED driver chip on the same daisy-chain.

As shown in FIG. 11, taking the second LED driver chip on the daisy-chain as example, the FB terminal of the second LED driver chip is configured to be effective through MCU, and the FB terminal of the second LED driver chip is connected to the FB circuit of DC-DC voltage converter. Therefore, the voltage boost/buck results of the first two LED driver chips can directly affect the voltage regulation control of DC-DC voltage converter. This topology structure can more flexibly control the adjustment of external power voltage V_{LED} of the LED string, and flexibly adjust the use of FB terminal of each LED driver chip based on the actual wiring situation of PCB.

Provide an example to illustrate the voltage regulation process of LED AHC system shown in FIG. 11.

Firstly, take the aggregate voltage regulation information of the second LED driver chip as buck and the aggregate voltage regulation information of the last LED driver chip as boost as an example. It should be understood that in this case, the LED supply voltage output by the DC-DC voltage converter needs to be boosted to the desired value. At the beginning of voltage regulation, after each update of the aggregate voltage regulation information, the current of current sink at the FB terminal of the second LED driver chip will buck ΔI_{FB1}, while the current of current sink at the FB terminal of the last LED driver chip will boost ΔI_{FB2}. Therefore, the change in the LED supply voltage output by the DC-DC voltage converter is ΔV_{LED}=(ΔI_{FB2}−ΔI_{FB1})×R₁. Assuming ΔI_{FB2}=ΔI_{FB1}, then the LED supply voltage output by the DC-DC voltage converter will not change for a period of time after the start of voltage regulation. With the voltage regulation, the current of current sink at the PB terminal of the second LED driver chip will gradually buck to 0 before no longer change, while the current of current sink at the FB terminal of the last LED driver chip will continue to boost. As a result, the LED supply voltage output by the DC-DC voltage converter begins to boost till reaching the desired value. Compared with only the FB terminal of the last LED driver chip participating in voltage regulation, in this case, the time required for voltage regulation is extended.

Then, take the aggregate voltage regulation information of the second LED driver chip as boost and the aggregate voltage regulation information of the last LED driver chip also as boost as an example. It should be understood that in this case, the LED supply voltage output by the DC-DC voltage converter needs to be boosted to the desired value. After each update of the voltage regulation information, the change in the LED supply voltage output by the DC-DC voltage converter is ΔV_{LED}=(ΔI_{FB2}+ΔI_{FB1})×R₁ till reaching the desired value. Compared with only the FB terminal of the last LED driver chip participating in voltage regulation, in this case, the time required for voltage regulation is shortened.

In other cases, the voltage regulation process of LED AHC system shown in FIG. 11 may be analogized by referring to the above two situations.

It can be seen that when the FB terminal of the non-last LED driver chip on the daisy-chain is connected to the FB circuit of DC-DC voltage converter, it only affects the time taking for the DC-DC voltage converter to adjust the output LED supply voltage, instead of affecting the accuracy of total amount of voltage regulation.

### Example 5

At least 1 of the LED driver chip, AHC system and method described in the previous examples is used for backlight driving of LCD, including but not limited to LCD displays for TV, computers, mobile phones and automobiles. When driving the backlight of this type of LCD screen, multiple command types are required to configure the working parameters and LED brightness information for each LED driver chip through a daisy-chain BUS method using MCU. The characteristic of backlight driving for this type of LCD screen is that the MCU needs to periodically send VSYNC commands via BUS to achieve refresh synchronization of the display screen. In this example, it is preferable to integrate the aggregate voltage regulation informatic of each LED driver chip into the existing VSYNC command of LCD screen for transmission.

Specifically, the MCU periodically sends VSYNC commands, which consist of a frame header, data and frame footer, where at least one bit in the data is a boost/buck information. After receiving a piece of data, the first LED driver chip on the daisy-chain determines whether it is a VSYNC command through the frame header. If it is, the first chip combines its own voltage regulation information with the initial voltage regulation information contained in the VSYNC command, updates the voltage regulation information bits in the VSYNC command, and sends the updated VSYNC command (including the aggregate voltage regulation information of the first LED driver chip) to the second LED driver chip. After receiving the VSYNC command, the second LED driver chip synthesizes its own voltage regulation information with the boost/buck information in the received VSYNC command, updates the boost/buck information bits in the VSYNC command based on the synthesis result, and then sends the updated VSYNC command (including the aggregate voltage regulation information of the second LED driver chip) to the third LED driver chip; and so on till the last LED driver chip receiving the VSYNC command. Thus, the last LED driver chip can summarize the voltage regulation information of all LED driver chips on the same daisy-chain and adjust the voltage accordingly.

It should be understood that the initial boost/buck information contained in the VSYNC command issued by the MCU should be buck, that is, the result of combining the initial boost/buck information with the own regulating information of the first LED driver chip, which is consistent with the own regulating information of the first LED driver chip.

### Example 6

This example is similar to example 5, but in this example, it is preferred to integrate the aggregate voltage regulation information of each LED driver chip into other types of existing periodic commands, or to send it through a new periodic command.

It should be noted that the above examples are only used to illustrate the technical solution of the present invention, but not to limit it. Although the aforementioned examples have provided detailed explanations of the present invention, those skilled in the art should understand that they may modify the technical solutions described in the aforementioned examples, or equivalently replace some or all of the technical features therein, without departing from the essence of the corresponding technical solutions from the scope of present invention.

1. A type of LED driver chip, including:
AHC module, used to collect the headroom voltage information of all OUT terminals such chip and summarize it to obtain the local voltage regulation information of LED driver chip; Characterized in that: further including:
Judge module, connected to the AHC module such chip, and receive the own regulating information sent by the AHC module such chip; and,
When at least two LED driver chips are connected to an MCU via BUS to form a daisy-chain, the Judge module is also used for:
When such chip is the first one on the daisy-chain, the aggregate voltage regulation information of such chip is obtained based on the own regulating information sent by the AHC module such chip. When such chip is not the first LED driver chip on the daisy-chain, the aggregate voltage regulation information of such chip is obtained based on the aggregate voltage regulation information of the previous LED driver chip sent by the previous LED driver chip on the same daisy-chain via BUS and the own regulating information sent by the AHC module of such chip; Meanwhile,
When such chip is not the last LED driver chip on the daisy-chain, the aggregate voltage regulation information of such chip is sent to the next LED driver chip on the same daisy-chain via BUS. When such chip is the last LED driver chip on the daisy-chain, the current of the FB terminal current sink of such chip is controlled to boost/buck based on the aggregate voltage regulation information of such chip, so as to adjust the LED power voltage output by the DC-DC voltage converter.

2. LED driver chip as claimed in claim 1, characterized in that: when the LED driver chip is not the last LED driver chip on the daisy-chain, its FB terminal is suspended. Alternatively, its FB terminal may be connected to the FB circuit of DC-DC voltage converter to jointly affect the LED supply voltage regulated by the DC-DC voltage converter with the last LED driver chip on the same daisy-chain.

3. A LED adaptive margin control system, characterized in that: including at least 1 daisy-chain formed by connecting at least 2 LED driver chips as claimed in claim 1 to an MCU through a communication bus. For the LED driver chips on the same daisy-chain, the FB terminal of the last LED driver chip is connected to the FB circuit of DC-DC voltage converter to provide control current to the FB circuit of DC-DC voltage converter.

4. LED AHC system as claimed in claim 3, characterized in that: for LED driver chips on the same daisy-chain, the FB terminals of all LED driver chips except for the last one is suspended.

5. LED AHC system as claimed in claim 3, characterized in that: for the LED driver chips on the same daisy-chain, at least 1 LED driver chip among the other LED driver chips except for the last one is connected to the FB circuit of DC-DC voltage converter at its FB terminal, so as to jointly affect the LED supply voltage regulated by the DC-DC voltage converter with the last LED driver chip on the same daisy-chain.

6. A type of LED AHC method, characterized in that: Including periodically executing:
Step 1: The first LED driver chip on daisy-chain collects the headroom voltage information of its OUT terminal to form its own voltage regulation information, and sends the local voltage regulation information as the aggregate voltage regulation information of the driver chip to the next LED driver chip on the same daisy-chain via BUS;
Step 2: Other LED driver chips on the daisy-chain, except for the first and last LED driver chips, collect the headroom voltage information of their OUT terminals to form their own voltage regulation information, and based on the local regulation information and the summary regulation information of the previous LED driver chip sent by the previous LED driver chip, obtain the summary regulation information of LED driver chip, and send the summary regulation information of LED driver chip to the next LED driver chip via BUS;
Step 3: The last LED driver chip on the daisy-chain collects the headroom voltage information of its OUT terminal to form its own voltage regulation information, and obtains the total voltage regulation information of LED driver chip based on the local voltage regulation information and the aggregate voltage regulation information of the previous LED driver chip sent by the previous LED driver chip, and based on the aggregate voltage regulation information of the LED driver chip, controls the current sink of output FB terminal of LED driver chip to boost/buck, so as to adjust the LED supply voltage output by the DC-DC voltage converter.

7. LED AHC method as claimed in claim 6, characterized in that: for the LED driver chips on the same daisy-chain, the FB terminals of other LED driver chips except for the last one is suspended, that is, they do not participate in the regulation of the LED power voltage output by the DC-DC voltage converter.

8. LED AHC method as claimed in claim 6, characterized in that: for the LED driver chips on the same daisy-chain, at least 1 LED driver chip among the other LED driver chips except for the last one is connected to the FB circuit of DC-DC voltage converter at its FB terminal, so as to jointly affect the LED supply voltage regulated by the DC-DC voltage converter with the last LED driver chip on the same daisy-chain.

9. The LED AHC system as claimed in claim 3, characterized in that: when the LED driver chip is not the last LED driver chip on the daisy-chain, its FB terminal is suspended; and alternatively, its FB terminal may be connected to the FB circuit of DC-DC voltage converter to jointly affect the LED supply voltage regulated by the DC-DC voltage converter with the last LED driver chip on the same daisy-chain.
